(19) United States
(12) Patent Application Publication
(10) Pub. No.: US 2024/0151265 A1
(43) Pub. Date: May 9, 2024

(54) WHEEL BEARING DEVICE

(71) Applicant: NTN CORPORATION, Osaka (JP)

(72) Inventor: Teruaki FUJIO, Shizuoka (JP)

(21) Appl. No.: 18/281,609

(22) PCT Filed: Mar. 11, 2022
(86) PCT No.: PCT/JP2022/011084

§ 371 Date: Sep. 12, 2023

(30) Foreign Application Priority Data
Mar. 24, 2021 (JP) 2021-050564

(51) Int. Cl. F16C 19/18

(52) U.S. Cl. CPC F16C 19/186; F16C 2326/02

(57) ABSTRACT

In a wheel bearing device, an axial end surface of a hub 1 of a wheel bearing 6 and an axial end surface of an outer joint member 20 of a constant velocity universal joint 7 are coupled by a recess-and-protrusion fitting structure (face spline structure X) in a torque transmittable manner. An inner peripheral surface of the hub 1 of the wheel bearing 6 and an outer peripheral surface of the outer joint member 20 of the constant velocity universal joint 7 are fitted to each other.

### TECHNICAL FIELD

The present invention relates to a wheel bearing device.

### BACKGROUND ART

A wheel bearing device includes a wheel bearing having an outer member fixed to a vehicle body, an inner member including a hub, and a plurality of rows of rolling elements disposed therebetween, and a constant velocity universal joint is known. In most cases, when fixing the inner member and an outer joint member of the constant velocity universal joint, the inner diameter of the hub and a stem part of the outer joint member are spline-fitted to enable power transmission. However, in recent years, face splines that are meshed with each other in the axial direction may be formed on an end surface of the hub and an end surface of the outer joint member abutting on the end surface of the hub (see Patent Literature 1, for example). In the wheel bearing device having a face spline structure, the hub and the outer joint member are fixed by fastening a bolt.

### CITATIONS LIST

### Patent Literature

Patent Literature 1: JP 5039048 B2

### SUMMARY OF INVENTION

### Technical Problems

In the wheel bearing device as described above, when torque is transmitted with a large operating angle of the constant velocity universal joint, the outer joint member receives a bending force (force for inclining axial center of outer joint member with respect to axial center of hub) by the secondary moment generated from the constant velocity universal joint. In a structure in which the hub and the stem part of the outer joint member are coupled by spline fitting, the shaft diameter of the stem part is large, and thus the inclination (bending) of the outer joint member with respect to the hub hardly occurs. However, in the case of the face spline structure, since the bolt used for fastening the hub and the outer joint member is thinner than the stem part of the outer joint member in the spline fitting structure, deflection is likely to occur due to the secondary moment. For this reason, the outer joint member is inclined with respect to the hub, the face spline fitting surfaces of the hub and the outer joint member are peeled off, and in the worst case, the face spline part may be damaged and torque transmission may be hindered.

In view of the above problem, an object of the present invention is to enhance the rotational performance (torque transmission performance) in a wheel bearing device in which a hub of a wheel bearing and an outer joint member of a constant velocity universal joint are fixed by a face spline structure.

### Solutions to Problems

In order to solve the above problem, the present invention provides a wheel bearing device including:
a wheel bearing including an outer member having double row outer raceway surfaces formed on an inner peripheral surface, an inner member having double row inner raceway surfaces formed on an outer peripheral surface so as to face the outer raceway surfaces, and a plurality of rows of rolling elements interposed between the outer raceway surfaces of the outer member and the inner raceway surfaces of the inner member; and a constant velocity universal joint having an outer joint member, an inner joint member, and a torque transmission member that transmits torque between the outer joint member and the inner joint member,
an axial end surface of the inner member of the wheel bearing and an axial end surface of the outer joint member of the constant velocity universal joint being coupled to each other in a torque transmittable manner by a recess-and-protrusion fitting structure, in which
an inner peripheral surface of the inner member of the wheel bearing and an outer peripheral surface of the outer joint member of the constant velocity universal joint are fitted to each other.

In this way, by fitting the inner peripheral surface of the inner member of the wheel bearing and the outer peripheral surface of the outer joint member of the constant velocity universal joint, a bending force (force to incline with respect to inner member of wheel bearing) applied to the outer joint member of the constant velocity universal joint due to the secondary moment generated when the constant velocity universal joint is used at a large operating angle can be received by the fitting part. As a result, the bending rigidity between the outer joint member of the constant velocity universal joint and the inner member of the wheel bearing is increased, so that the recess-and-protrusion fitting part (face spline part) between the end surfaces of the outer joint member and the inner member can be prevented from being peeled off.

Specifically, for example, a protruding part protruding toward the wheel bearing (outboard side) may be provided on an inner diameter side of an uneven surface forming the recess-and-protrusion fitting structure in the outer joint member of the constant velocity universal joint, and an outer peripheral surface of the protruding part of the outer joint member and the inner peripheral surface of the inner member of the wheel bearing may be fitted to each other.

Alternatively, a cylindrical part protruding toward the constant velocity universal joint (inboard side) may be provided on an outer diameter side of an uneven surface forming the recess-and-protrusion fitting structure in the inner member of the wheel bearing, and an inner peripheral surface of the cylindrical part of the inner member and the outer peripheral surface of the outer joint member may be fitted to each other.

### Advantageous Effects of Invention

As described above, according to the present invention, the bending rigidity between the inner member of the wheel bearing and the outer joint member of the constant velocity universal joint is enhanced, so that torque transmission performance between the inner member and the outer joint member is enhanced.

### BRIEF DESCRIPTION OF DRAWINGS

FIG. 1 is a cross-sectional view of a wheel bearing device according to an embodiment of the present invention.

FIG. 2 is a cross-sectional view of a wheel bearing device according to another embodiment.

### DESCRIPTION OF EMBODIMENT

Hereinafter, an embodiment of the present invention will be described with reference to the drawings. Note that in the following description, in a state where a wheel bearing device is assembled to a vehicle body, a side close to the outside of the vehicle body is referred to as an outboard side (left side in drawing), and a side close to the center of the vehicle body is referred to as an inboard side (right side in drawing).

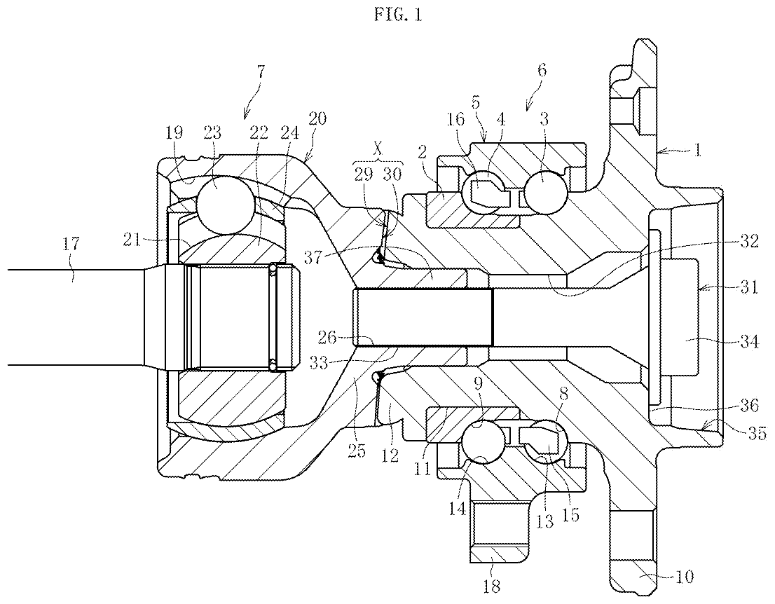

A wheel bearing device illustrated in FIG. 1 mainly includes a wheel bearing 6 and a constant velocity universal joint 7. The wheel bearing 6 includes an inner member including a hub 1 and an inner ring 2, an outer member including an outer ring 5, and a plurality of rows of rolling elements 3 and 4.

The hub 1 has an inner raceway surface 8 on the outboard side formed on an outer peripheral surface, and includes a wheel mounting flange 10 for mounting a wheel (not illustrated). The inner ring 2 is fitted to a small-diameter step part 1I formed on the inboard-side outer peripheral surface of the hub 1. An inner raceway surface 9 on the inboard side is formed on an outer peripheral surface of the inner ring 2.

The inner raceway surface 8 on the outboard side formed on the outer peripheral surface of the hub 1 and the inner raceway surface 9 on the inboard side formed on the outer peripheral surface of the inner ring 2 form double row raceway surfaces. The inner ring 2 is press-fitted into the small-diameter step part 11 of the hub 1, an inboard side end part of the small-diameter step part 11 is riveted outward by orbital forming, and a resultant riveted part 12 retains and integrates the inner ring 2 with the hub 1 to apply a preload to the wheel bearing 6.

In the outer ring 5, double row outer raceway surfaces 13 and 14 facing the inner raceway surfaces 8 and 9 of the hub 1 and the inner ring 2 are formed on an inner peripheral surface. The outer ring 5 has a body mounting flange 18 for mounting on a knuckle (not illustrated) extending from a suspension device of the vehicle body.

The wheel bearing 6 including the hub 1, the inner ring 2, and the outer ring 5 has a double row angular ball bearing structure. Specifically, the rolling elements 3 and 4 are interposed between the inner raceway surfaces 8 and 9 formed on the outer peripheral surfaces of the hub 1 and the inner ring 2 and the outer raceway surfaces 13 and 14 formed on the inner peripheral surface of the outer ring 5. The rolling elements 3 and 4 in each row are supported at equal intervals in the circumferential direction by retainers 15 and 16.

The constant velocity universal joint 7 is a fixed type constant velocity universal joint forming a part of a drive shaft, and is connected to one end of an intermediate shaft 17. The constant velocity universal joint 7 includes an outer joint member 20 in which a track groove 19 is formed on an inner peripheral surface, an inner joint member 22 in which a track groove 21 facing the track groove 19 of the outer joint member 20 is formed on an outer peripheral surface, a ball 23 as a torque transmission member incorporated between the track groove 19 of the outer joint member 20 and the track groove 21 of the inner joint member 22, and a cage 24 interposed between the inner peripheral surface of the outer joint member 20 and the outer peripheral surface of the inner joint member 22 to hold the ball 23.

The outer joint member 20 accommodates internal components including the inner joint member 22, the ball 23, and the cage 24. A female screw part 26 penetrating in the axial direction is formed in a bottom part 25 of the outer joint member 20. The inner joint member 22 and an axial end of the intermediate shaft 17 are coupled in a torque transmittable manner by spline fitting.

The wheel bearing device includes the following recess-and-protrusion fitting structure (face spline structure X) in which the hub 1 of the wheel bearing 6 and the outer joint member 20 of the constant velocity universal joint 7 are coupled in a torque transmittable manner.

A face spline 29 in which a plurality of protrusions and recesses extending in the radial direction are alternately formed in the circumferential direction is formed on an end surface on the inboard side of the hub 1 of the wheel bearing 6, that is, on an end surface on the inboard side of the riveted part 12 of the hub 1 in the example of FIG. 1. The face spline 29 is formed by plastic working, and is formed, for example, simultaneously with orbital forming of the riveted part 12. In addition, a face spline 30 in which a plurality of protrusions and recesses extending in the radial direction are alternately formed in the circumferential direction is formed on an end surface on the outboard side of the outer joint member 20 of the constant velocity universal joint 7, that is, on an end surface on the outboard side of the bottom part 25 of the outer joint member 20 in the example of FIG. 1. The face spline 30 is formed by plastic working, for example, simultaneously with the forging of the outer joint member 20. Note that the face splines 29 and 30 may be formed by machining such as cutting.

The inboard-side end surface of the riveted part 12 of the hub 1 and the outboard-side end surface of the bottom part 25 of the outer joint member 20 are abutted with each other, and the face splines 29 and 30 thereof are meshed with each other, thereby forming the face spline structure X as a recess-and-protrusion fitting structure. When the face splines 29 and 30 are engaged in the rotational direction, torque is transmitted between the outer joint member 20 and the hub 1.

Further, the wheel bearing device has the following fastening structure using a bolt 31. That is, the bolt 31 is inserted into a through hole 32 provided at the axial center of the hub 1, and a male screw part 33 formed at the tip end of the bolt 31 is screwed into the female screw part 26 formed in the bottom part 25 of the outer joint member 20. Then, the bolt 31 is tightened in a state where a head part 34 of the bolt 31 is locked to a bottom surface 36 of a recess 35 provided on an end surface on the outboard side of the hub 1. In this way, the face spline 29 of the riveted part 12 of the hub 1 and the face spline 30 of the bottom part 25 of the outer joint member 20 are pressed against each other by the axial force due to tightening of the bolt 31, whereby the constant velocity universal joint 7 and the hub 1 are fixed in a torque transmittable manner.

While the overall configuration of the wheel bearing device in this embodiment is as described above, the fitting structure between the outer peripheral surface of the outer joint member 20 and the inner peripheral surface of the hub 1 as a characteristic configuration will be described below.

In the wheel bearing device, the outer peripheral surface of the outer joint member 20 and the inner peripheral surface of the hub 1 are fitted to each other. Specifically, a protruding part 37 protruding to the outboard side is provided on the inner diameter side of the face spline 30 of the outer joint member 20. In the example of FIG. 1, the protruding part 37 is formed in a tubular shape, and the female screw part 26 to which the bolt 31 is screwed is formed on the inner peripheral surface. In the example of FIG. 1, the outboard side end of the protruding part 37 extends to the outboard side from the inboard side end of the inner ring 2. The outer peripheral surface of the protruding part 37 is fitted to the inner peripheral surface of the through hole 32 of the hub 1. In the example of FIG. 1, cylindrical surfaces are provided on both the outer peripheral surface of the protruding part 37 and the inner peripheral surface of the through hole 32 of the hub 1, and these cylindrical surfaces are fitted to each other. The outer peripheral surface of the protruding part 37 and the inner peripheral surface of the hub 1 have substantially the same diameter, and are fitted to each other with a slight fitting gap or with a slight interference. The fitting gap between the outer peripheral surface of the protruding part 37 and the inner peripheral surface of the hub 1 is set to, for example, 5 μm or less.

When torque is transmitted with a large operating angle of the constant velocity universal joint 7, a bending force for tilting the axis with respect to the hub 1 is applied to the outer joint member 20 by the secondary moment generated in the constant velocity universal joint 7. In the conventional wheel bearing device, the bending of the outer joint member 20 and the hub 1 as described above is restricted by a contact part (face spline structure X) between the end surfaces of the outer joint member 20 and the hub 1 and the bolt 31. In the present embodiment, since the outer peripheral surface of the protruding part 37 of the outer joint member 20 and the inner peripheral surface of the hub 1 are fitted as described above, it is possible to more reliably restrict the bending of the outer joint member 20 and the hub 1 by engaging them in the bending direction (direction in which axes thereof are inclined). As a result, it is possible to prevent the face splines 29 and 30 formed on the end surfaces of the outer joint member 20 and the hub 1 from being peeled off, so that torque can be reliably transmitted via the face splines 29 and 30.

The present invention is not limited to the above embodiment. Hereinafter, while other embodiments of the present invention will be described, overlapping descriptions of points similar to those of the above embodiment will be omitted.

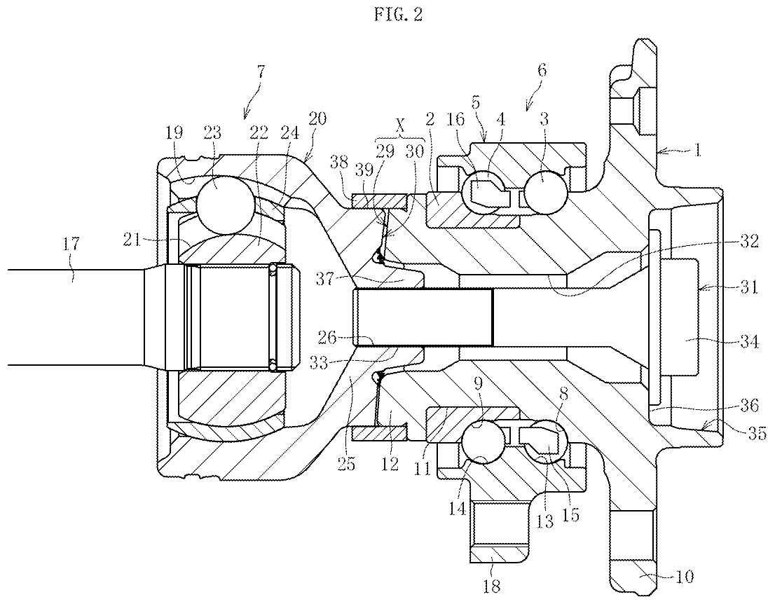

In an embodiment illustrated in FIG. 2, a cylindrical part 38 protruding to the inboard side is provided on the outer diameter side of a spline 29 of a hub 1, and an inner peripheral surface of the cylindrical part 38 and an outer peripheral surface of the outer joint member 20 are fitted to each other. In the example of FIG. 2, the cylindrical part 38 is formed of a member formed separately from the hub 1. After a riveted part 12 is formed in the hub 1, a cylindrical surface is processed on an outer peripheral surface of the riveted part 12, and the inner peripheral surface of the cylindrical part 38 is fitted and fixed (e.g., press-fitted) to the cylindrical surface. A cylindrical surface 39 is formed on the outer peripheral surface of the outer joint member 20. The cylindrical inner peripheral surface of the cylindrical part 38 of an inner member of a wheel bearing 6 and the cylindrical surface 39 of the outer peripheral surface of the outer joint member 20 have substantially the same diameter, and are fitted to each other with a slight fitting gap or with a slight interference. With this fitting part, bending rigidity between the outer joint member 20 and the hub 1 can be increased.

In the above embodiment, the cylindrical surface provided on the outer joint member 20 of a constant velocity universal joint 7 and the cylindrical surface provided on the inner member (hub 1) of the wheel bearing 6 are fitted to each other. However, the present invention is not limited to this. For example, polygonal surfaces having a polygonal cross section may be provided on both the outer joint member 20 and the hub 1, and the polygonal surfaces may be fitted to each other. Alternatively, tapered surfaces inclined with respect to the axial direction may be provided on both the outer joint member 20 and the hub 1, and the tapered surfaces may be fitted to each other.

### REFERENCE SIGNS LIST

1 Hub (inner member)
2 Inner ring (inner member)
3, 4 Rolling element
5 Outer ring (outer member)
6 Wheel bearing
7 Constant velocity universal joint
12 Riveted part
20 Outer joint member
22 Inner joint member
23 Ball (torque transmission member)
24 Cage
29, 30 Face spline
31 Bolt
37 Protruding part
38 Cylindrical part
X Face spline structure (recess-and-protrusion fitting structure)

1. A wheel bearing device comprising:
a wheel bearing including an outer member having double row outer raceway surfaces formed on an inner peripheral surface, an inner member having double row inner raceway surfaces formed on an outer peripheral surface so as to face the outer raceway surfaces, and a plurality of rows of rolling elements interposed between the outer raceway surfaces of the outer member and the inner raceway surfaces of the inner member; and
a constant velocity universal joint having an outer joint member, an inner joint member, and a torque transmission member that transmits torque between the outer joint member and the inner joint member,
an axial end surface of the inner member of the wheel bearing and an axial end surface of the outer joint member of the constant velocity universal joint being coupled to each other in a torque transmittable manner by a recess-and-protrusion fitting structure, wherein
an inner peripheral surface of the inner member of the wheel bearing and an outer peripheral surface of the outer joint member of the constant velocity universal joint are fitted to each other.

2. The wheel bearing device according to claim 1, wherein
a protruding part protruding toward the wheel bearing is provided on an inner diameter side of an uneven surface forming the recess-and-protrusion fitting structure in the outer joint member of the constant velocity universal joint, and
an outer peripheral surface of the protruding part of the outer joint member and the inner peripheral surface of the inner member of the wheel bearing are fitted to each other.

3. The wheel bearing device according to claim 1, wherein
a cylindrical part protruding toward the constant velocity universal joint is provided on an outer diameter side of an uneven surface forming the recess-and-protrusion fitting structure in the inner member of the wheel bearing, and
an inner peripheral surface of the cylindrical part of the inner member and the outer peripheral surface of the outer joint member are fitted to each other.
